(19) United States
(12) Patent Application Publication
(10) Pub. No.: US 2012/0127930 A1
(43) Pub. Date: May 24, 2012

(54) UPLINK DATA ARRIVAL RANDOM ACCESS PROCEDURE

(75) Inventors: Bao Vinh Nguyen, Corona, CA (US); Shailesh Maheshwari, San Diego, CA (US); Girish Khandelwal, San Diego, CA (US); Mouaffac Ambriss, San Diego, CA (US)

(73) Assignee: QUALCOMM INCORPORATED, San Diego, CA (US)

(21) Appl. No.: 12/951,938

(22) Filed: Nov. 22, 2010

(51) Int. Cl. H04W 12/06

(52) U.S. Cl. 370/329

(57) ABSTRACT

User equipment (UE) transmits an access response to a random access procedure (RACH) preamble message to acquire an uplink grant from a node of a wireless communication system. The access response provides an uplink grant to the UE for a request for authorization to transmit uplink data to the node. In response to determining that the access response message provides an uplink grant sufficient to empty the UE's data buffer, the UE transmits the request for authorization including the uplink data to the node. The UE can then terminate the RACH procedure without requiring any subsequent uplink grant from the node, having accomplished successful data transmission using the request for authorization.

### BACKGROUND

I. Field

The following description relates generally to wireless communications systems, and more particularly to uplink data arrival in a wireless communications network.

II. Background

Wireless communication systems are widely deployed to provide various types of communication content such as voice, data, and so forth. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems including Evolved UTRA (E-UTRA), and orthogonal frequency division multiple access (OFDMA) systems. Each of the foregoing systems operates over licensed frequency spectrums, and licensee operators generally provide access to users according to a subscription model. The technology described herein pertains to these and similar systems.

An orthogonal frequency division multiplex (OFDM) communication system effectively partitions the overall system bandwidth into multiple (N_{F}) subcarriers, which may also be referred to as frequency sub-channels, tones, or frequency bins. For an OFDM system, the data to be transmitted (i.e., the information bits) is first encoded with a particular coding scheme to generate coded bits, and the coded bits are further grouped into multi-bit symbols that are then mapped to modulation symbols. Each modulation symbol corresponds to a point in a signal constellation defined by a particular modulation scheme (e.g., M-ary Phase-Shift Keying (M-PSK) or Multi-Level Quadrature Amplitude Modulation (M-QAM)) used for data transmission. At each time interval that may be dependent on the bandwidth of each frequency subcarrier, a modulation symbol may be transmitted on each of the N_{F} frequency subcarrier. Thus, OFDM may be used to combat inter-symbol interference (ISI) caused by frequency selective fading, which is characterized by different amounts of attenuation across the system bandwidth.

Generally, a wireless multiple-access communication system can concurrently support communication for multiple wireless terminals such as mobile stations, also called user equipment (UE), that communicate with one or more base stations via transmissions on forward and reverse links. The downlink (or forward link) refers to the communication link from the base stations to the mobile stations, and the reverse link (or uplink) refers to the communication link from the mobile stations to the base stations. This communication link may be established via a single-in-single-out, multiple-in-signal-out or a multiple-in-multiple-out (MIMO) system.

A MIMO system employs multiple (N_{T}) transmit antennas and multiple (NR) receive antennas for data transmission. A MIMO channel formed by the N_{T} transmit and N_{R} receive antennas may be decomposed into N_{S} independent channels, which are also referred to as spatial channels. Generally, each of the N_{S} independent channels corresponds to a dimension. The MIMO system can provide improved performance (e.g., higher throughput and/or greater reliability) if the additional dimensionalities created by the multiple transmit and receive antennas are utilized. A MIMO system also supports time division duplex (TDD) and frequency division duplex (FDD) systems.

Uplink data arrival protocols govern uplink of data from the UE to the base station in many wireless communication systems, and different protocols may apply to different circumstances within the same system. For example, the Evolved Universal Terrestrial Radio Access (E-UTRA) Medium Access Control (MAC) protocol specification specifies that an Uplink Data Arrival (ULDAR) Random Access Channel (RACH) procedure is performed for uplink of data under certain conditions. Use of the RACH procedure or similar methods requiring contention resolution may sometimes result in less than optimal efficiency in data transfer. A new or modified implementation of a RACH procedure would therefore be desirable, to overcome these and other limitations of random access channel procedures requiring contention resolution.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in a simplified form as a prelude to the more detailed description that is presented later.

In accordance with one or more embodiments and corresponding disclosure thereof, various aspects are described in connection with methods for femtocell access control. The methods may be performed in a wireless communication network comprising at least one base station or node configured for wireless communication with user equipment (UE) accessing the network via the base station or node. The wireless communication network may be any one of the group consisting of a Session Initiation Protocol (SIP) based circuit-switched network, an Interoperability Specification (IOS) based circuit-switched network, and a packet-switched network

The methods may include receiving, an access response to a random access channel (RACH) procedure preamble message to acquire an uplink grant from a node of a wireless communication system. The RACH procedure may be as specified by a 3GPP Long Term Evolution (LTE) protocol, or may be a similar procedure as used in another wireless communication protocol. The access response provides an uplink data grant to at user equipment (UE) for a request for authorization to transmit uplink data to the node. The access response may also include a Temporary Cell Radio Network Temporary ID (temporary C-RNTI or T-RNTI), which is a form of Cell Radio Network Temporary ID (C-RNTI) Media Access Control (MAC) control element used during the RACH procedure and discarded afterwards. The methods may further include transmitting the request for authorization including the uplink data to the node, in response to determining that the access response message provides an uplink data grant sufficient to empty the UE's data buffer. Including the uplink data in the request for authorization enables termination of the RACH procedure without requiring any subsequent uplink data grant from the node. Thus, contention resolution is resolved more efficiently and efficiency of communication is improved.

The methods may further include the UE providing an indication that the UE's data buffer is empty, in the request for authorization. The UE may perform providing the indication using a Buffer Status Report (BSR) data signal. The methods may further include initializing a contention resolution timer in response to transmitting the request for authorization.

In addition, or in the alternative, the UE may include the T-RNTI in the request for authorization. The methods may further comprise the UE stopping the contention resolution timer and discarding the T-RNTI, in response to receiving a Physical Downlink Control Channel (PDCCH) transmission addressed to the T-RNTI after transmitting the request for authorization.

In addition, or in the alternative, the UE may include a Common Control Channel (CCCH) Service Data Unit (SDU) in the request for authorization. The methods may further comprise the UE stopping the contention resolution timer and discarding the T-RNTI, in response to determining that a UE Contention Resolution Identity decoded from a MAC Protocol Data Unit (PDU) matches the CCCH SDU. The methods may further comprise the UE disassembling and demultiplexing the MAC PDU, further in response to determining that a UE Contention Resolution Identity decoded from a MAC Protocol Data Unit (PDU) matches the CCCH SDU.

The methods may further comprise the UE discarding the T-RNTI in response to expiration of the contention resolution timer. The methods may further comprise the UE reinitiating the RACH procedure for uplink of data after waiting for a backoff period.

The technology may also be embodied in a communications apparatus; for example, in user equipment implementing a wireless communication protocol. That apparatus includes a memory that retains instructions for performing any of the methods summarized above, and a processor that executes the instructions. For example, the instructions may provide for receiving an access response to a RACH procedure preamble message to acquire an uplink grant from a node of a wireless communication system. The instructions may further provide that the access response provides a uplink data grant to the UE for a request for authorization to transmit uplink data to the node. The instructions may further provide transmitting the request for authorization including the uplink data to the node, in response to determining that the access response message provides a uplink data grant sufficient to empty the UE's data buffer. Including the uplink data in the request for authorization enables termination of the RACH procedure without requiring any subsequent uplink data grant from the node. Thus, the apparatus can more efficiently resolve RACH contention resolution when the amount of uplink data is small enough to be included in the RACH request for authorization. The apparatus may therefore be used to improve efficiency of communication in the wireless communication network.

The technology may also be embodied in a computer program product; for example, a computer-readable medium storing code for causing a computer to perform any of the methods summarized above. For example, the code may cause a UE to receive an access response to a RACH procedure preamble message to acquire an uplink grant from a node of a wireless communication system. The access response may provide a uplink data grant to the UE for a request for authorization to transmit uplink data to the node. The code may further cause the computer to transmit the request for authorization including the uplink data to the node, in response to determining that the access response message provides a uplink data grant sufficient to empty the UE's data buffer. By causing the UE to include the uplink data in the request for authorization, the computer program product enables termination of the RACH procedure without requiring any subsequent uplink data grant from the node. Thus, the computer program product can more efficiently resolve RACH contention resolution when the amount of uplink data is small enough to be included in the RACH request for authorization. The computer program product may therefore be used to improve efficiency of communication in the wireless communication network.

In addition, a communications apparatus for performing the methods may comprise means for performing any of the methods described herein, such as either of the apparatus summarized above. For example, an apparatus may comprise first means for receiving, at user equipment implementing a wireless communication protocol, an access response to a RACH procedure preamble message to acquire an uplink grant from a node of a wireless communication system, wherein the access response provides a uplink data grant to the UE for a request for authorization to transmit uplink data to the node. The apparatus may further comprise second means coupled to the first means, the second means for transmitting the request for authorization including the uplink data to the node in response to determining that the access response message provides a uplink data grant sufficient to empty the UE's data buffer, thereby enabling termination of the RACH procedure without requiring any subsequent uplink data grant from the node. Thus, the apparatus can more efficiently resolve RACH contention resolution when the amount of uplink data is small enough to be included in the RACH request for authorization, and thereby improve efficiency of communication in the wireless communication network.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

Throughout the drawings and accompanying description, like reference characters identify correspondingly like elements.

FIG. 1 is a flow diagram showing a method for an uplink data arrival random access procedure.

FIG. 2 illustrates a multiple access wireless communication system including a mobile station and a base station.

FIG. 3 illustrates an exemplary wireless communication system.

FIG. 4 illustrates an exemplary communication system including different types of access point base stations within a network environment.

FIG. 5 is a block diagram showing examples of a base station and user equipment as may be used to perform an ULDAR RACH procedure as disclosed herein.

FIG. 6 is a sequence diagram showing an example of a sequence for performing an ULDAR RACH procedure with uplink after contention resolution.

FIG. 7 is a sequence diagram showing an example of a sequence for performing an ULDAR RACH procedure with uplink prior to contention resolution.

FIG. 8 is a block diagram showing an example of an apparatus for performing an ULDAR RACH procedure.

FIG. 9 is a flow diagram showing additional actions that may be performed in some embodiments of an ULDAR RACH procedure.

FIG. 10 is a block diagram showing an example of an apparatus for performing the additional actions illustrated by FIG. 9.

FIG. 11 is a flow diagram showing additional actions that may be performed in embodiments of an ULDAR RACH procedure in which the UE transmits a temporary C-RNTI MAC control element to the base station.

FIG. 12 is a block diagram showing an example of an apparatus for performing the additional actions illustrated by FIG. 11.

FIG. 13 is a flow diagram showing additional actions that may be performed in embodiments of an ULDAR RACH procedure in which the UE transmits a CCCH SDU to the base station.

FIG. 14 is a block diagram showing an example of an apparatus for performing the additional actions illustrated by FIG. 13.

FIG. 15 is a flow diagram showing relationships between actions that may be performed by user equipment in different embodiments of an ULDAR RACH procedure.

### DETAILED DESCRIPTION

The Evolved Universal Terrestrial Radio Access (E-UTRA) Medium Access Control (MAC) protocol specification (3GPP TS 36.321 V 8.5.0 Section 5.1) specifies that an Uplink Data Arrival (ULDAR) Random Access Channel (RACH) procedure is performed for uplink of data under certain conditions. These conditions may include, for example, the UE detecting high data arrival while the uplink timing is out of sync or the Scheduling Request (SR) resource is not available. To successfully complete an ULDAR via a RACH, the RACH procedure may be required to successfully pass contention resolution. If contention resolution is not passed, the UE may perform the RACH procedure continuously until the Radio Resource Control (RRC) times out, alerting the UE to Radio Link Failure (RLF). Therefore, systems, apparatus and methods are provided to enable an ULDAR RACH procedure to accomplish data uplink without requiring an uplink data grant from a RACH contention resolution sequence, or in which RACH contention resolution is terminated efficiently.

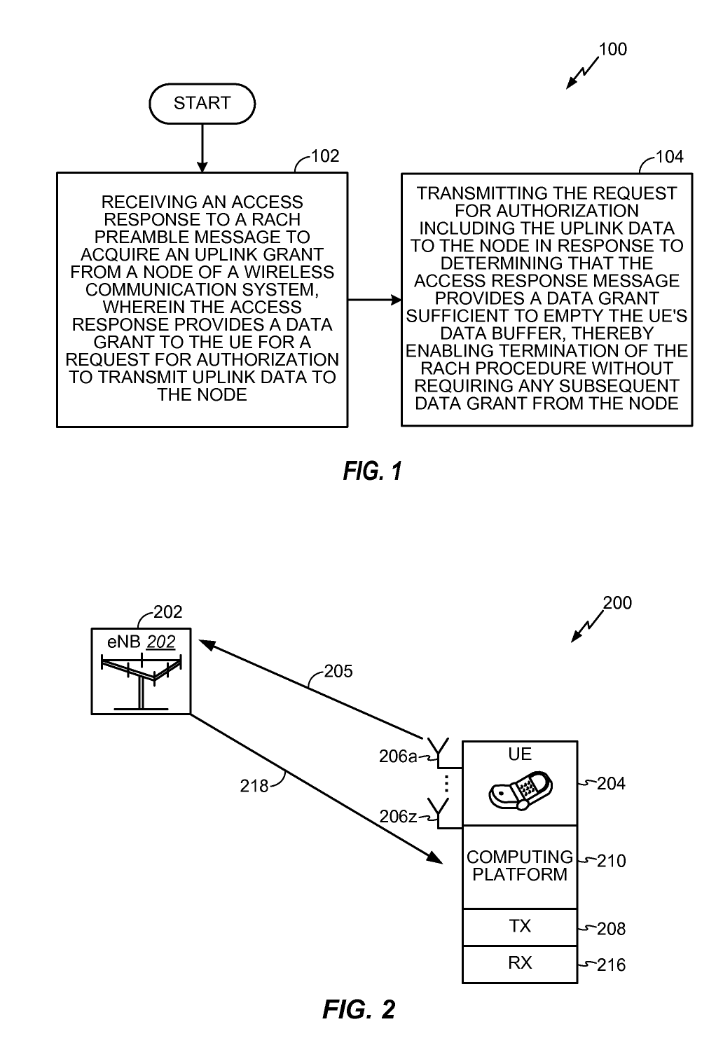

Aspects of a method 100 for performing an ULDAR RACH procedure are shown in FIG. 1. A RACH procedure may be initiated by a UE by transmitting a preamble message to a base station in a wireless communication network. In LTE, the preamble message may be referred to as “message 1,” which may be abbreviated as “MSG1.” A preamble message is characterized by being an efficient wireless signal indicating that the UE seeks to initiate a RACH procedure for uplink of data, namely by requesting an uplink grant. The preamble is designed to carry minimal information so as to conserve system resources, and therefore does not include any information about the data to be uplinked by the UE. In an aspect, the UE will seek to initiate a RACH procedure for uplink of data in response to detecting data arrival while either of the following conditions apply: (1) uplink timing out of sync, or (2) the Scheduling Request (SR) resource is not available.

In response to the preamble, the base station may transmit an access response message to the UE. In LTE, the access response message may be referred to as “message 2,” which may be abbreviated as “MSG2.” An access response may be characterized by providing a small uplink grant to the UE. The uplink grant may be large enough to allow the UE to transmit a request for authorization to the base station, and may vary depending on system parameters or may be fixed depending on the applicable protocol. In an aspect, the access response message may also transmit a temporary identifier to the UE, such as, for example, a temporary C-RNTI. In a further aspect, the access response message may transmit timing instructions to the UE for a request for authorization.

Accordingly, method 100 may comprise the UE receiving 102 an access response to a RACH preamble message to acquire an uplink grant from a node (e.g., base station) of a wireless communication system, wherein the access response provides an uplink grant to the UE. In an aspect, the uplink grant received at step 102 is not for the uplink data; i.e., is not for the arrived data detected by the UE and stored in its buffer for uplink. Instead, the uplink grant is for the UE to transmit a request for authorization to transmit uplink data to the node (e.g., base station), because the preamble does not provide the base station with any information about the data to be uplinked, other than that the UE is seeking to uplink data. For example, the preamble does not include information about the amount of information to be uplinked. A purpose of the access response is to provide the UE with a uplink grant, which the UE can use to transmit information about the data to be uplinked in a request for authorization, including the amount of data to be uplinked.

In LTE, the RACH request for authorization may be referred to as “message 3,” which may be abbreviated as “MSG3.” A request for authorization may be characterized as being a scheduled transmission as specified by the access response. In addition to including data as specified herein, the access response may include an identifier for the UE, for example, a C-RNTI and/or the temporary C-RNTI, and a report indicating an amount of data in the UE's uplink data buffer.

In response to the access response from the base station, the UE may determine whether or not the uplink grant provided by the access response is large enough to transmit the data to be uplinked. In response to determining that the access response message provides a uplink grant sufficient to empty the UE's data buffer, the UE may transmit 104 the request for authorization to the node, including the uplink data stored in its uplink data buffer. The UE may also include a control signal in the request for authorization, to indicate to the receiving node that the request for authorization includes uplink data. For example, the UE may include a signal indicating that its uplink data buffer is empty. Transmitting the request for authorization including the uplink data enables termination of the RACH procedure without requiring a subsequent uplink data grant from the receiving node.

For example, if the request for authorization includes data emptying the UE's uplink data buffer, and therefore includes a buffer status report (BSR) indicating zero data remains to be uplinked, the base station may, in response, transmit a contention resolution message to the UE that does not include an uplink data grant. In response to receiving such as contention resolution message, the UE may terminate the RACH procedure. In LTE, the contention resolution message may be referred to as “message 4,” which may be abbreviated as “MSG4.” The contention resolution message may be characterized by resolving the RACH procedure, such as by providing an uplink grant for the UE or by providing other information enabling the UE to terminate the RACH procedure without subsequent uplink of data. Thus, the UE accomplishes uplink of data more efficiently, using fewer system resources. Further details and various embodiments of method 100 in different contexts are provided by the following detailed disclosure.

Having described an example of an ULDAR RACH at a relatively high level of generality, examples of contexts in which the methods and apparatus described herein should be useful will be provided. Referring to FIG. 2, a Multiple Input Multiple Output (MIMO) communication system 200 between an evolved Base Node (eNB) 202 and User Equipment (UE) 204 utilizes a RACH procedure for an uplink 205 across a plurality of transmit (Tx) antennas 206a-206z. In particular, a transmitter 208 of the UE 204 transmits uplink data and other signals as described elsewhere herein from antennas 206a-206z in response to a computing platform 210 determining that the RACH access response message provides an uplink grant sufficient to empty the UE's data buffer. A receiver (Rx) 216 of the UE 204 can receive a downlink 218 from the eNB 202, for example, downlink portions of a RACH contention resolution procedure and other data.

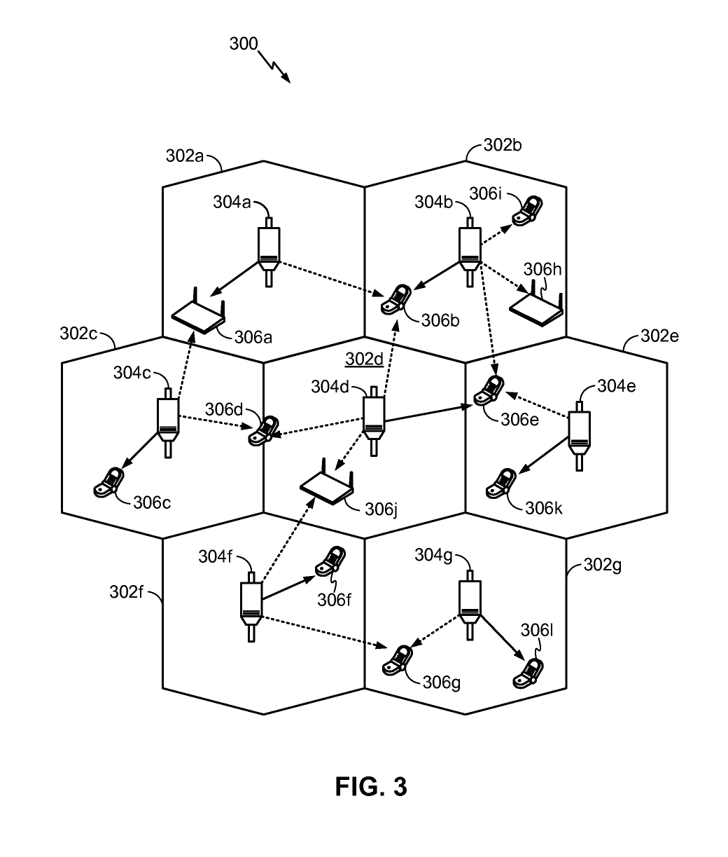

FIG. 3 illustrates a wireless communication system 300, configured to support a number of users, in which the teachings herein may be implemented. The system 300 provides communication for multiple cells 302, such as, for example, macro cells 302a-302g, with each cell being serviced by a corresponding access node 304 (e.g., access nodes 304a-304g). As shown in FIG. 3, access terminals 306 (e.g., access terminals 306a-3061) may be dispersed at various locations throughout the system over time. Each access terminal 306 may communicate with one or more access nodes 304 on a forward link (“FL”) and/or a reverse link (“RL) at a given moment, depending upon whether the access terminal 306 is active and whether it is in soft handoff, for example. The wireless communication system 300 may provide service over a large geographic region. For example, macro cells 302a-302g may cover a few blocks in a neighborhood.

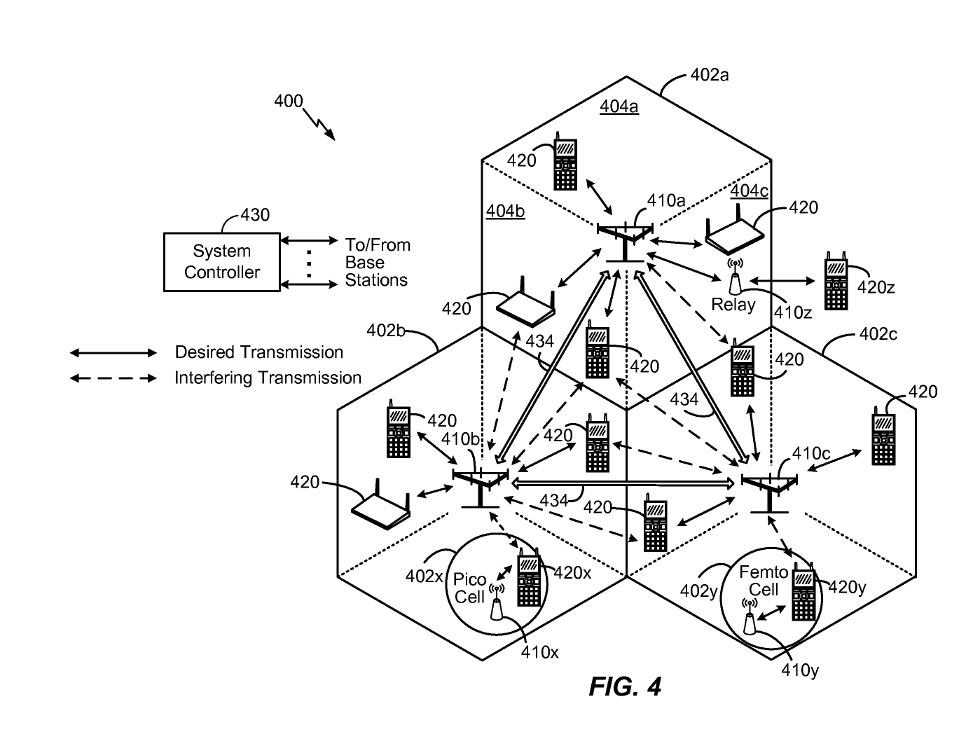

In the example shown in FIG. 4, base stations 410a, 410b and 410c may be macro base stations for macro cells 402a, 402b and 402c, respectively. Base station 410x may be a pico base station for a pico cell 402x communicating with terminal 420x. Base station 410y may be a femto base station for a femto cell 402y communicating with terminal 420y. Although not shown in FIG. 4 for simplicity, the macro cells may overlap at the edges. The pico and femto cells may be located within the macro cells (as shown in FIG. 4) or may overlap with macro cells and/or other cells.

Wireless network 400 may also include relay stations, e.g., a relay station 410z that communicates with terminal 420z. A relay station is a station that receives a transmission of data and/or other information from an upstream station and sends a transmission of the data and/or other information to a downstream station. The upstream station may be a base station, another relay station, or a terminal. The downstream station may be a terminal, another relay station, or a base station. A relay station may also be a terminal that relays transmissions for other terminals. A relay station may transmit and/or receive low reuse preambles. For example, a relay station may transmit a low reuse preamble in similar manner as a pico base station and may receive low reuse preambles in similar manner as a terminal.

A network controller 430 may couple to a set of base stations and provide coordination and control for these base stations. Network controller 430 may be a single network entity or a collection of network entities. Network controller 430 may communicate with base stations 410 via a backhaul. Backhaul network communication 434 can facilitate point-to-point communication between base stations 410a-410c employing such a distributed architecture. Base stations 410a-410c may also communicate with one another, e.g., directly or indirectly via wireless or wireline backhaul.

Wireless network 400 may be a homogeneous network that includes only macro base stations (not shown in FIG. 4). Wireless network 400 may also be a heterogeneous network that includes base stations of different types, e.g., macro base stations, pico base stations, home base stations, relay stations, etc. These different types of base stations may have different transmit power levels, different coverage areas, and different impact on interference in wireless network 400. For example, macro base stations may have a high transmit power level (e.g., 20 Watts) whereas pico and femto base stations may have a low transmit power level (e.g., 9 Watt). The techniques described herein may be used for homogeneous and heterogeneous networks.

Terminals 420 may be dispersed throughout wireless network 400, and each terminal may be stationary or mobile. A terminal may also be referred to as an access terminal (AT), a mobile station (MS), user equipment (UE), a subscriber unit, or a station. A terminal may be a cellular phone, a personal digital assistant (PDA), a wireless modem, a wireless communication device, a handheld device, a laptop computer, a cordless phone, a wireless local loop (WLL) station, etc. A terminal may communicate with a base station via the downlink and uplink. The downlink (or forward link) refers to the communication link from the base station to the terminal, and the uplink (or reverse link) refers to the communication link from the terminal to the base station.

A terminal may be able to communicate with macro base stations, pico base stations, femto base stations, and/or other types of base stations. In FIG. 4, a solid line with double arrows indicates desired transmissions between a terminal and a serving base station, which is a base station designated to serve the terminal on the downlink and/or uplink. A dashed line with double arrows indicates interfering transmissions between a terminal and a base station. An interfering base station is a base station causing interference to a terminal on the downlink and/or observing interference from the terminal on the uplink.

Wireless network 400 may support synchronous or asynchronous operation. For synchronous operation, the base stations may have the same frame timing, and transmissions from different base stations may be aligned in time. For asynchronous operation, the base stations may have different frame timing, and transmissions from different base stations may not be aligned in time. Asynchronous operation may be more common for pico and femto base stations, which may be deployed indoors and may not have access to a synchronizing source such as a Global Positioning System (GPS).

In one aspect, to improve system capacity, the coverage area 402a, 402b, or 402c corresponding to a respective base station 410a-410c can be partitioned into multiple smaller areas (e.g., areas 404a, 404b, and 404c). Each of the smaller areas 404a, 404b, and 404c can be served by a respective base transceiver subsystem (BTS, not shown). As used herein and generally in the art, the term “sector” can refer to a BTS and/or its coverage area depending on the context in which the term is used. In one example, sectors 404a, 404b, 404c in a cell 402a, 402b, 402c can be formed by groups of antennas (not shown) at base station 410, where each group of antennas is responsible for communication with terminals 420 in a portion of the cell 402a, 402b, or 402c. For example, a base station 410 serving cell 402a can have a first antenna group corresponding to sector 404a, a second antenna group corresponding to sector 404b, and a third antenna group corresponding to sector 404c. However, it should be appreciated that the various aspects disclosed herein can be used in a system having sectorized and/or unsectorized cells. Further, it should be appreciated that all suitable wireless communication networks having any number of sectorized and/or unsectorized cells are intended to fall within the scope of the hereto appended claims. For simplicity, the term “base station” as used herein can refer both to a station that serves a sector as well as a station that serves a cell. It should be appreciated that as used herein, a downlink sector in a disjoint link scenario is a neighbor sector. While the following description generally relates to a system in which each terminal communicates with one serving access point for simplicity, it should be appreciated that terminals can communicate with any number of serving access points.

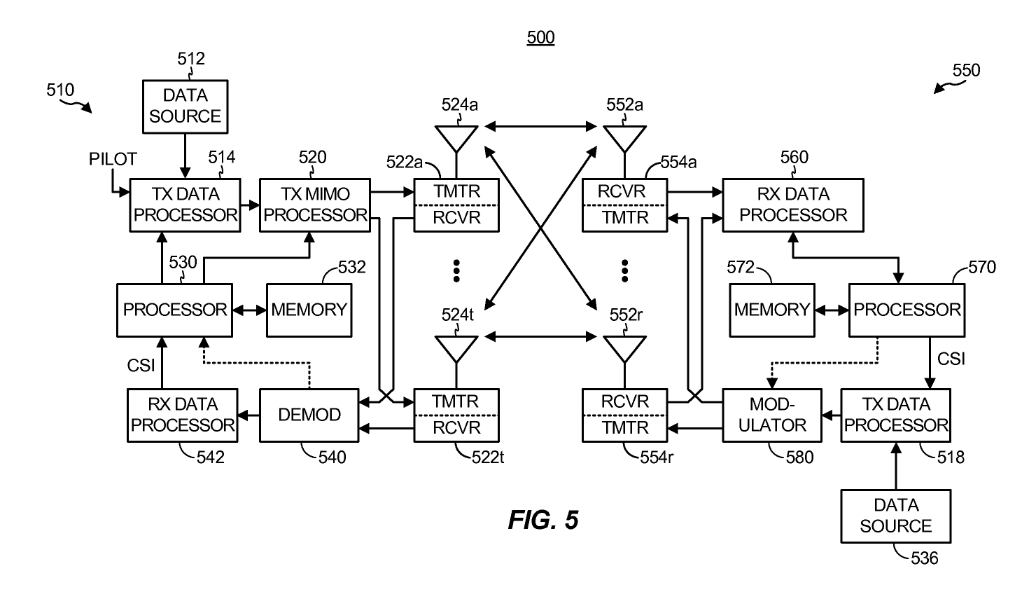

The teachings herein may be incorporated into a node (e.g., a device) employing various components for communicating with at least one other node. FIG. 5 depicts several sample components that may be employed to facilitate communication between nodes. Specifically, FIG. 5 illustrates a wireless device 510 (e.g., an access point) and a wireless device 550 (e.g., an access terminal or UE) of a MIMO system 500. At the device 510, traffic data for a number of data streams is provided from a data source 512 to a transmit (“TX”) data processor 514.

In some aspects, each data stream is transmitted over a respective transmit antenna. The TX data processor 514 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., Binary Phase Shift Keying (BPSK), Quadrature Phase Shift Keying (QSPK), M-ary Phase Shift Keying (M-PSK), or Multi-Level Quadrature Amplitude Modulation (M-QAM)) selected for that data stream to provide modulation symbols. The data rate, coding, and modulation for each data stream may be determined by instructions performed by a processor 530. A data memory 532 may store program code, data, and other information used by the processor 530 or other components of the device 510. For example, the data memory 532 may store code and data used by the processor 530 to perform the base station side of an Uplink Data Arrival (ULDAR) Random Access Channel (RACH) procedure, as disclosed hereon.

The modulation symbols for all data streams are then provided to a TX MIMO processor 520, which may further process the modulation symbols (e.g., for Orthogonal Frequency-Division Multiplexing (OFDM)). The TX MIMO processor 520 then provides NT modulation symbol streams to NT transceivers (“XCVR”) 522a through 522t that each has a transmitter (TMTR) and receiver (RCVR). In some aspects, the TX MIMO processor 520 applies beam-forming weights to the symbols of the data streams and to the antenna from which the symbol is being transmitted.

Each transceiver 522a-522t receives and processes a respective symbol stream to provide one or more analog signals, and further conditions (e.g., amplifies, filters, and upconverts) the analog signals to provide a modulated signal suitable for transmission over the MIMO channel. NT modulated signals from transceivers 522a through 522t are then transmitted from NT antennas 524A through 524T, respectively.

At the device 550, the transmitted modulated signals are received by NR antennas 552A through 552R and the received signal from each antenna 552A-552R is provided to a respective transceiver (“XCVR”) 554a through 554r. Each transceiver 554a-554r conditions (e.g., filters, amplifies, and downconverts) a respective received signal, digitizes the conditioned signal to provide samples, and further processes the samples to provide a corresponding “received” symbol stream.

A receive (“RX”) data processor 560 then receives and processes the NR received symbol streams from NR transceivers 554a-554r based on a particular receiver processing technique to provide NT “detected” symbol streams. The RX data processor 560 then demodulates, deinterleaves, and decodes each detected symbol stream to recover the traffic data for the data stream. The processing by the RX data processor 560 is complementary to that performed by the TX MIMO processor 520 and the TX data processor 514 at the device 510.

A processor 570 periodically determines which pre-coding matrix to use. The processor 570 formulates a reverse link message comprising a matrix index portion and a rank value portion. A data memory 572 may store program code, data, and other information used by the processor 570 or other components of the device 550. For example, the data memory 572 may store code and data used by the processor 570 to perform the user equipment side of an Uplink Data Arrival (ULDAR) Random Access Channel (RACH) procedure, as disclosed hereon.

The reverse link message may comprise various types of information regarding the communication link and/or the received data stream. The reverse link message is then processed by a TX data processor 538, which also receives traffic data for a number of data streams from a data source 536, modulated by a modulator 580, conditioned by the transceivers 554a through 554r, and transmitted back to the device 810.

At the device 510, the modulated signals from the device 550 are received by the antennas 524A-524T, conditioned by the transceivers 522a-522t, demodulated by a demodulator (“DEMOD”) 540, and processed by a RX data processor 542 to extract the reverse link message transmitted by the device 550. The processor 530 then determines which pre-coding matrix to use for determining the beam-forming weights then processes the extracted message.

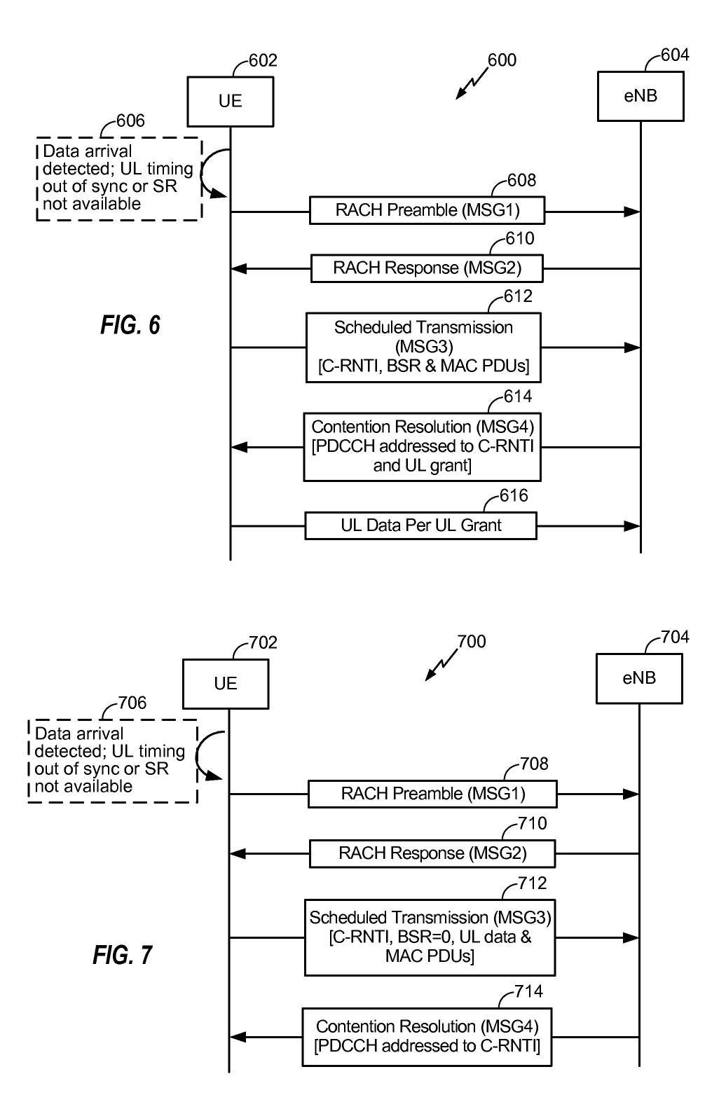

An ULDAR RACH procedure 600 in which, to pass contention resolution the UE 602 must receive a Physical Downlink Control Channel (PDCCH) message from the eNB (base station) 604 addressed to the Cell Radio Network Temporary ID (C-RNTI) for the UE and containing an uplink grant is illustrated by FIG. 6. Procedure 600 may not be optimal in circumstances where the amount of data in the UE's uplink data buffer is small enough to be transmitted in an uplink grant of a request for authorization. Nonetheless, the procedure 600 may provide a comparison and context for more optimal procedures and methods described herein.

The UE 602 may initiate the ULDAR RACH procedure 600 on response to detecting data arrival 606 while the UE's uplink timing is out of sync with the eNB 604, or while the system's scheduling resource is not available. Such conditions are not uncommon in many wireless communication systems. A RACH procedure may be initiated 608 by the UE 602 by transmitting a preamble message 608 to the base station 604. The preamble message 608, also referred to herein as “MSG1,” may be characterized by being an efficient wireless signal indicating that the UE 602 seeks to initiate a RACH procedure for uplink of data, namely by requesting an uplink grant from the base station 604. The preamble is designed to carry minimal information so as to conserve system resources, and therefore does not include any information about the data to be uplinked by the UE. For example, the preamble does not indicate the amount of data that the UE 602 needs to uplink to the eNB 604.

The eNB 604 responds to MSG1 by transmitting a RACH access response 610, also referred to herein as “MSG2,” to the UE 602. The MSG2 610 includes an uplink grant to permit the UE 602 to transmit metadata and other information to the eNB 604 to enable efficient uplink of data from the UE 602 for use in the wireless communications network. Advantageously, the uplink grant is relatively small so that the base station does not over allocate resources to UE's having a relatively small amount of data to uplink. In some circumstances, the uplink grant may be a minimum size; for example, large enough to transmit a request for authorization to enable efficient uplink of data from the UE 602, but no larger. In other circumstances, the uplink grant allocated in MSG3 may be somewhat larger than minimum size, as determined by the eNB in response to current conditions. For example, if the eNB 604 determines that it has excess capacity for receiving uplink data, it may provide an uplink grant in MSG2 that is larger than minimum size. However, in many circumstances the eNB 604 may not make any determination of capacity or larger grant, instead simply providing an uplink grant in MSG2 that is a predetermined size, for example a minimum size.

The UE 602 may respond to the MSG2 access response by transmitting a request for authorization for a scheduled transmission 612, also referred to herein as a “MSG3,” to the eNB 604. The UE may include metadata and other information in a MSG3 response 612 to the eNB 604 to enable efficient scheduled uplink of data from the UE 602 for use in the wireless communications network. For example, the UE 602 may transmit its C-RNTI, an indication of a non-zero amount of data in its uplink data buffer, such as a buffer status report (BSR), and MAC package data units (PDUs), in the MSG3 request for authorization.

In response to the MSG3 request for authorization, the eNB 604 may generate and transmit a contention resolution response 614 using the PDCCH addressed to the C-RNTI for the UE 602. The contention resolution response 614 may also be referred to herein as a “MSG4.” The MSG4 response 614 includes an uplink grant to the UE 602 of a size large enough for the UE to uplink an amount of data equal to or greater than the amount of data indicated in the MSG3 BSR. In response to the MSG4 grant 614, the UE 602 uplinks 616 the data in its uplink data buffer to the eNB 604, as indicated by the uplink grant. Thus, the ULDAR RACH provides for efficient uplink when the amount of data to be uplinked exceeds the size of the uplink grant provided by MSG2 610.

However, it is not uncommon for UE to have only a small amount of data to uplink, that is, an amount small enough to utilize the uplink grant provided by MSG2 in the RACH procedure 600. Under such conditions, a modified ULDAR RACH procedure 700 may be used, as diagramed by FIG. 7. The procedure 700 maybe performed using a UE 702 and eNB (base station) 704, which may be similar to, or the same as, the UE 602 and eNB 604 used for procedure 600, except for being equipped using suitable software or firmware to perform the operations required for procedure 700. The initial determination 706 or procedure 700 may be the same as the determination 606 described for procedure 600. Likewise, the MSG1 preamble 708 of procedure 700 may be similar or identical to the MSG1 preamble 608 of procedure 600, while the MSG2 access response 710 may be similar or identical to the MSG2 access response 610.

The MSG3 request for authorization for scheduled transmission 712 in procedure 700, however, differs from its counterpart in procedure 600. The UE 702 may generate and transmit the MSG3 request 712 in response to determining that the amount of data in the UE's uplink data buffer is small enough to utilize the uplink grant provided by MSG2 710. For example, the UE 702 may transmit its C-RNTI, an indication of zero data in its uplink data buffer, such as a buffer status report (BSR) indicating zero, MAC package data units (PDUs), and the data from the UE's uplink data buffer in the MSG3 request for authorization 712.

From the BSR zero indication, the eNB 704 recognizes the presence of data in the request 712, and handles the data for communication over the wireless communication network as indicated by control data from the UE 702. In addition, the eNB 704 recognizes that the UE does not need an additional uplink grant. Therefore, the eNB 704 may respond with a MSG4 contention resolution message 714 that contains no uplink grant; for example, a PDCCH message addressed to the C-RNTI indicated in MSG3 and lacking any further uplink grant. The UE 702 may, in response to the MSG4 714, terminate the ULDAR RACH procedure 700 without requiring any further uplink grant from the eNB 704 to empty the UE's uplink data buffer. Thus, procedure 700 provides for more efficient uplink under the specified conditions, which are recognized at the UE 702 at 706 and when responding to MSG2 710.

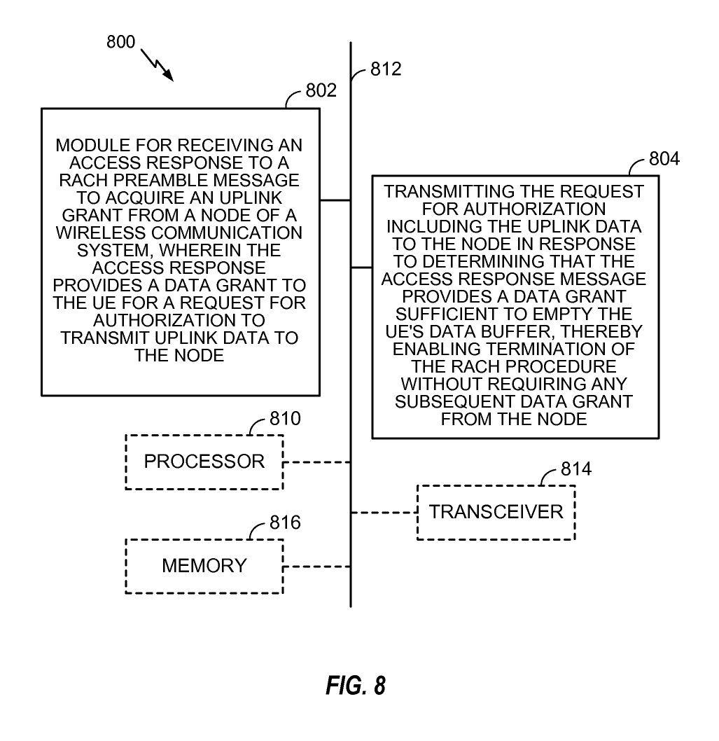

With reference to the forgoing figures and description, a method 100 for performing an ULDAR RACH procedure to uplink data may include steps and operations has been described above in connection with FIG. 1. Certain details pertinent to method 100 have been clarified by the discussion in connection with FIGS. 6-7, with procedure 700 in FIG. 7 pertaining to a procedure consistent with method 100. Further consistent with the method 100, and as further illustrated by FIG. 8, an apparatus 800 may function as user equipment in a wireless communication system. The apparatus 800 may comprise an electronic component or module 802 for receiving an access response to a RACH preamble message to acquire an uplink grant from a node of a wireless communication system, wherein the access response provides an uplink grant to the UE for a request for authorization to transmit uplink data to the node. The apparatus 800 further comprises a module 804 for transmitting the request for authorization including the uplink data to the node in response to determining that the access response message provides an uplink grant sufficient to empty the UE's data buffer, thereby enabling termination of the RACH procedure without requiring any subsequent uplink grant from the node.

The apparatus 800 may optionally include a processor module 810 having at least one processor; in the case of the apparatus 800 configured as a communication network entity, rather than as a general purpose microprocessor. The processor 810, in such case, may be in operative communication with the modules 802-804 via a bus 812 or similar communication coupling. The processor 810 may effect initiation and scheduling of the processes or functions performed by electrical components 802-804.

In related aspects, the apparatus 800 may include a transceiver module 814. A stand alone receiver and/or stand alone transmitter may be used in lieu of or in conjunction with the transceiver 814. In further related aspects, the apparatus 800 may optionally include a module for storing information, such as, for example, a memory device/module 816. The computer readable medium or the memory module 816 may be operatively coupled to the other components of the apparatus 800 via the bus 812 or the like. The memory module 816 may be adapted to store computer readable instructions and data for performing the processes of the modules 802-804, and subcomponents thereof, or the processor 810, or the methods disclosed herein, and other operations for wireless communications. The memory module 816 may retain instructions for executing functions associated with the modules 802-804. While shown as being external to the memory 816, the modules 802-804 can include at least portions within the memory 816.

In further related aspects, the memory 816 may optionally include executable code for the processor module 810 and/or ones of the modules 802-804 to cause the apparatus 800 to perform a method that comprises the steps of: (a) receiving, at user equipment (UE) implementing a wireless communication protocol, an access response to a random access channel (RACH) procedure preamble message to acquire an uplink grant from a node of a wireless communication system, wherein the access response provides an uplink grant to the UE for a request for authorization to transmit uplink data to the node; and (b) transmitting the request for authorization including the uplink data to the node in response to determining that the access response message provides an uplink grant sufficient to empty the UE's data buffer, thereby enabling termination of the RACH procedure without requiring any subsequent uplink grant from the node.

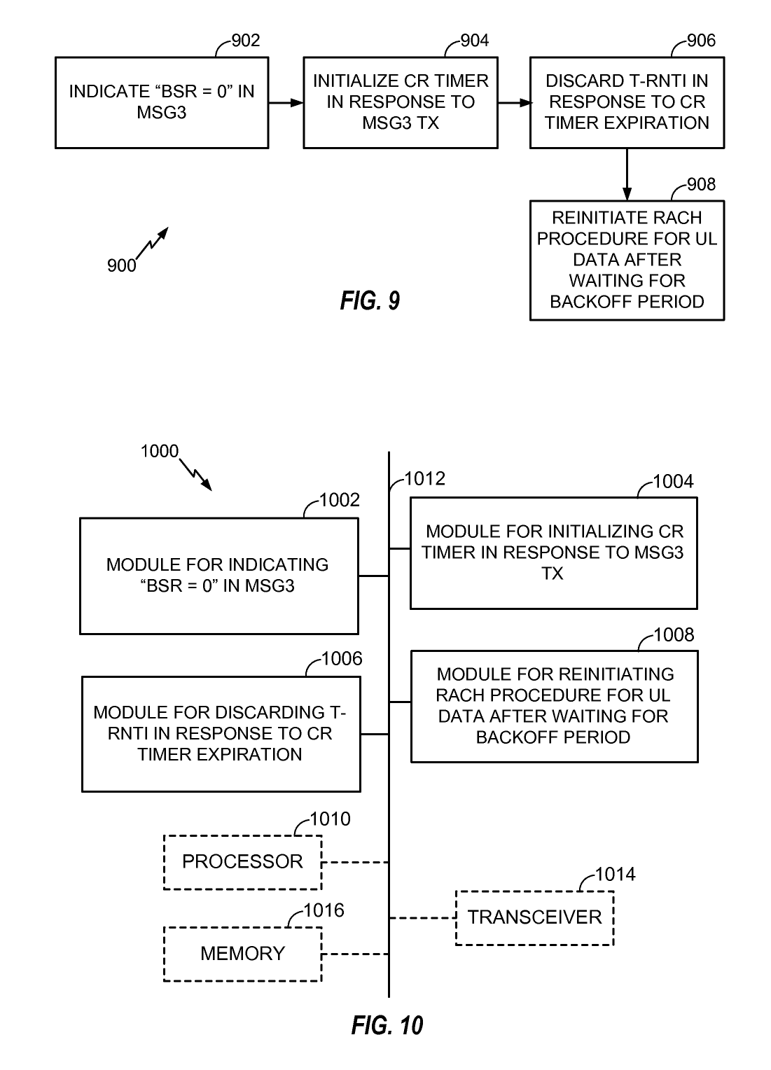

Further operations 900 that may be performed by a UE in conjunction with performing the steps of method 100 are shown in FIG. 9. In the MSG3 request for authorization, the UE may provide an indication that the UE's data buffer is empty 902. The indication may be provided 902 using a BSR signal. Furthermore, in response to transmitting the MSG3 request for authorization including uplink data, the UE may initialize a contention resolution (CR) timer 904. The UE may use the CR timer to determine whether contention resolution is successful within the predetermined period allowed by the timer.

If and when the CR timer expires or “times out,” the UE may discard the T-RNTI 906 assigned for the ULDAR RACH by MSG3, in response to the expiration of the timer. The UE therefore treats timer expiration as indicating that the ULDAR RACH procedure has not been successful. In such case, the UE may initiate the RACH procedure for the original uplink data after waiting for a defined backoff period 908. Conversely, if the UE receives a response from the base station acknowledging receipt of the UE's MSG3, as described in more detail below, the UE may regard the ULDAR RACH as being successful. In those cases where the UE regards the ULDAR RACH as successful, it does not reinitiate the RACH procedure unless and until it detects the arrival of new uplink data.

Consistent with the further operations 900, and as further illustrated by FIG. 10, an apparatus 1000 may function as user equipment in a wireless communication system. The apparatus 1000 may comprise an electronic component or module 1002 for providing an indication that the UE's data buffer is empty in the request for authorization (MSG3). The indication may be provided using the BSR to indicate that the buffer is empty, or zero. The apparatus 1000 may comprise an electronic component or module 1004 for initializing a contention resolution timer in response to transmitting the request for authorization to the base station. The apparatus 1000 may comprise an electronic component or module 1006 for discarding a temporary C-RNTI assigned to he UE in the request for authorization, in response to expiration of the contention resolution timer. The apparatus 1000 may comprise an electronic component or module 1008 for reinitiating an ULDAR RACH procedure at MSG1 for uplink of data from the UE, after waiting for a backoff period.

The apparatus 1000 may optionally include a processor module 1010 having at least one processor; in the case of the apparatus 1000 configured as a communication network entity, rather than as a general purpose microprocessor. The processor 1010, in such case, may be in operative communication with the modules 1002-1008 via a bus 1012 or similar communication coupling. The processor 1010 may effect initiation and scheduling of the processes or functions performed by electrical components 1002-1008.

In related aspects, the apparatus 1000 may include a transceiver module 1014. A stand alone receiver and/or stand alone transmitter may be used in lieu of or in conjunction with the transceiver 1014. In further related aspects, the apparatus 1000 may optionally include a module for storing information, such as, for example, a memory device/module 1016. The computer readable medium or the memory module 1016 may be operatively coupled to the other components of the apparatus 1000 via the bus 1012 or the like. The memory module 1016 may be adapted to store computer readable instructions and data for performing the functions of the modules 1002-1008, and subcomponents thereof, or the processor 1010, or the methods disclosed herein, and other operations for wireless communications. The memory module 1016 may retain instructions for executing functions associated with the modules 1002-1008. While shown as being external to the memory 1016, the modules 1002-1008 can include at least portions within the memory 1016. In further related aspects, the memory 1016 may optionally include executable code for the processor module 1010 and/or ones of the modules 1002-1008 to cause the apparatus 1000 to perform a method that comprises any operable combination of the additional operations 900 and method 100.

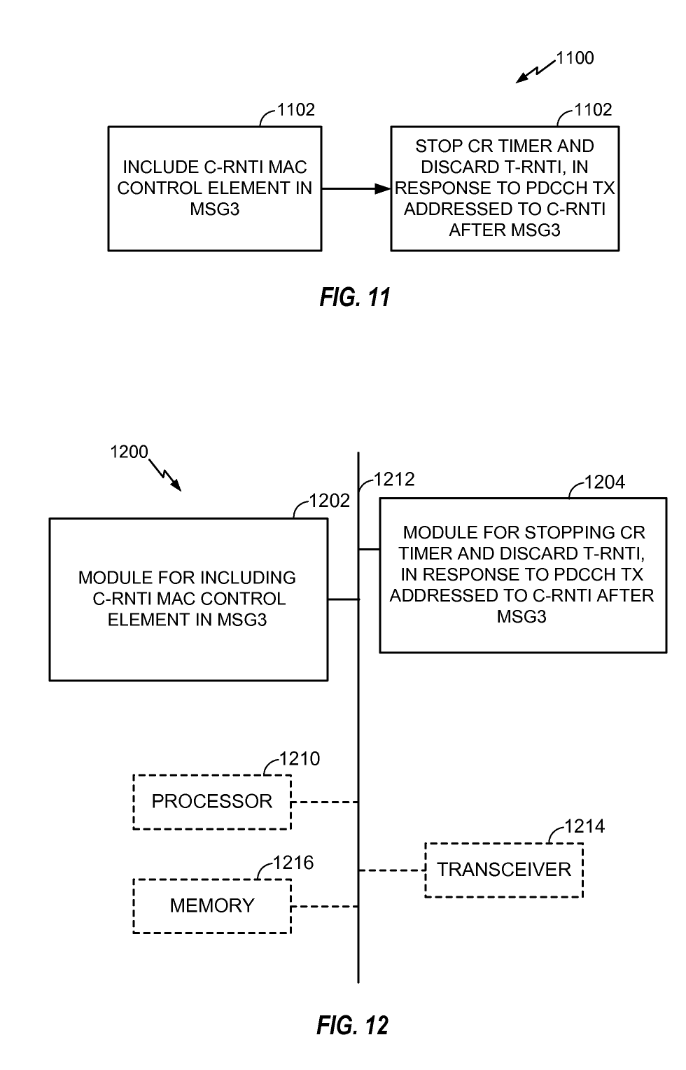

Further operations 1100 that may be performed by a UE in conjunction with performing the steps of method 100 and/or the additional operations 900 are shown in FIG. 11. The further operations 1100 apply to embodiments wherein the UE includes 1102 a C-RNTI MAC control element in the MSG3 request for authorization with the uplink data. In addition, the UE may initialize a contention resolution time as previously discussed in connection with FIG. 9. In such embodiments, the UE may stop the CR timer and discard the temporary C-RNTI 1104, in response to a PDCCH transmission addressed to the C-RNTI received after transmission of MSG3. The UE therefore uses receipt of the PDCCH transmission as an indication that the ULDAR RACH has successfully completed uplink of data from the UE.

Consistent with the further operations 1100, and as further illustrated by FIG. 12, an apparatus 1200 may function as user equipment in a wireless communication system. The apparatus 1200 may comprise an electronic component or module 1202 for including a C-RNTI MAC control element in the request for authorization (MSG3) transmitted from the EU to the base station. The apparatus 1200 may comprise an electronic component or module 1204 for stopping the contention resolution timer and discarding the temporary C-RNTI, in response to receiving a PDCCH transmission addressed to the C-RNTI after transmission of MSG3.

The apparatus 1200 may optionally include a processor module 1210 having at least one processor; in the case of the apparatus 1200 configured as a communication network entity, rather than as a general purpose microprocessor. The processor 1210, in such case, may be in operative communication with the modules 1202-1204 via a bus 1212 or similar communication coupling. The processor 1210 may effect initiation and scheduling of the processes or functions performed by electrical components 1202-1204.

In related aspects, the apparatus 1200 may include a transceiver module 1214. A stand alone receiver and/or stand alone transmitter may be used in lieu of or in conjunction with the transceiver 1214. In further related aspects, the apparatus 1200 may optionally include a module for storing information, such as, for example, a memory device/module 1216. The computer readable medium or the memory module 1216 may be operatively coupled to the other components of the apparatus 1200 via the bus 1212 or the like. The memory module 1216 may be adapted to store computer readable instructions and data for effecting the processes and behavior of the modules 1202-1204, and subcomponents thereof, or the processor 1210, or the methods disclosed herein, and other operations for wireless communications. The memory module 1216 may retain instructions for executing functions associated with the modules 1202-1204. While shown as being external to the memory 1216, the modules 1202-1204 can include at least portions within the memory 1216. In further related aspects, the memory 1216 may optionally include executable code for the processor module 1210 and/or ones of the modules 1202-1204 to cause the apparatus 1200 to perform a method that comprises any operable combination of the additional operations 1100, 900 and method 100.

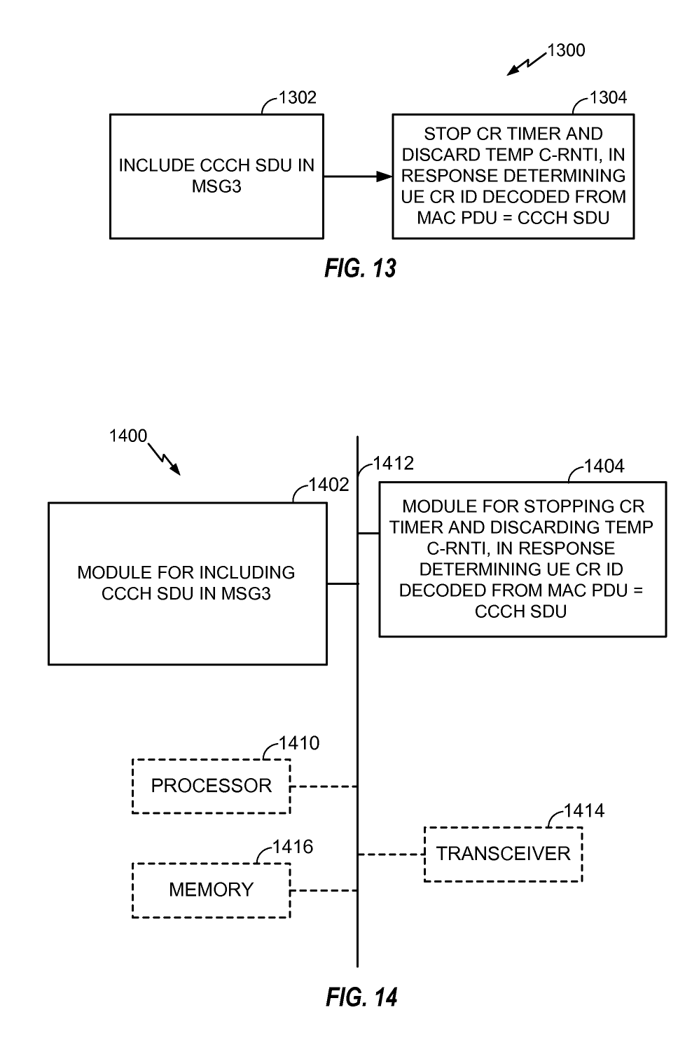

Further operations 1300 that may be performed by a UE in conjunction with performing the steps of method 100 and/or the additional operations 900 are shown in FIG. 13. The further operations 1300 apply to embodiments wherein the UE includes 1302 a CCCH SDU in the MSG3 request for authorization with the uplink data. In addition, the UE may initialize a contention resolution time as previously discussed in connection with FIG. 9. In such embodiments, the UE may stop the CR timer and discard a temporary C-RNTI 1304, in response to determining that a UE contention resolution ID decoded from a MAC PDU received from the base station after transmission of MSG3 matches the CCCH SDU. The UE therefore uses receipt of the MAC PDU as an indication that the ULDAR RACH has successfully completed uplink of data from the UE.

Consistent with the further operations 1300, and as further illustrated by FIG. 14, an apparatus 1400 may function as user equipment in a wireless communication system. The apparatus 1400 may comprise an electronic component or module 1402 for including CCCH SDU in the MSG3 request for authorization (MSG3) with the uplink data transmitted from the EU to the base station. The apparatus 1400 may comprise an electronic component or module 1404 for stopping stop the CR timer and discarding a temporary C-RNTI 1304, in response to determining that a UE contention resolution ID decoded from a MAC PDU received from the base station after transmission of MSG3 matches the CCCH SDU.

The apparatus 1400 may optionally include a processor module 1410 having at least one processor; in the case of the apparatus 1400 configured as a communication network entity, rather than as a general purpose microprocessor. The processor 1410, in such case, may be in operative communication with the modules 1402-1404 via a bus 1412 or similar communication coupling. The processor 1410 may effect initiation and scheduling of the processes or functions performed by electrical components 1402-1404.

In related aspects, the apparatus 1400 may include a transceiver module 1414. A stand alone receiver and/or stand alone transmitter may be used in lieu of or in conjunction with the transceiver 1414. In further related aspects, the apparatus 1400 may optionally include a module for storing information, such as, for example, a memory device/module 1416. The computer readable medium or the memory module 1416 may be operatively coupled to the other components of the apparatus 1400 via the bus 1412 or the like. The memory module 1416 may be adapted to store computer readable instructions and data for effecting the processes and behavior of the modules 1402-1404, and subcomponents thereof, or the processor 1410, or the methods disclosed herein, and other operations for wireless communications. The memory module 1416 may retain instructions for executing functions associated with the modules 1402-1404. While shown as being external to the memory 1416, the modules 1402-1404 can include at least portions within the memory 1416. In further related aspects, the memory 1416 may optionally include executable code for the processor module 1410 and/or ones of the modules 1402-1404 to cause the apparatus 1400 to perform a method that comprises any operable combination of the additional operations 1100, 900 and method 100.

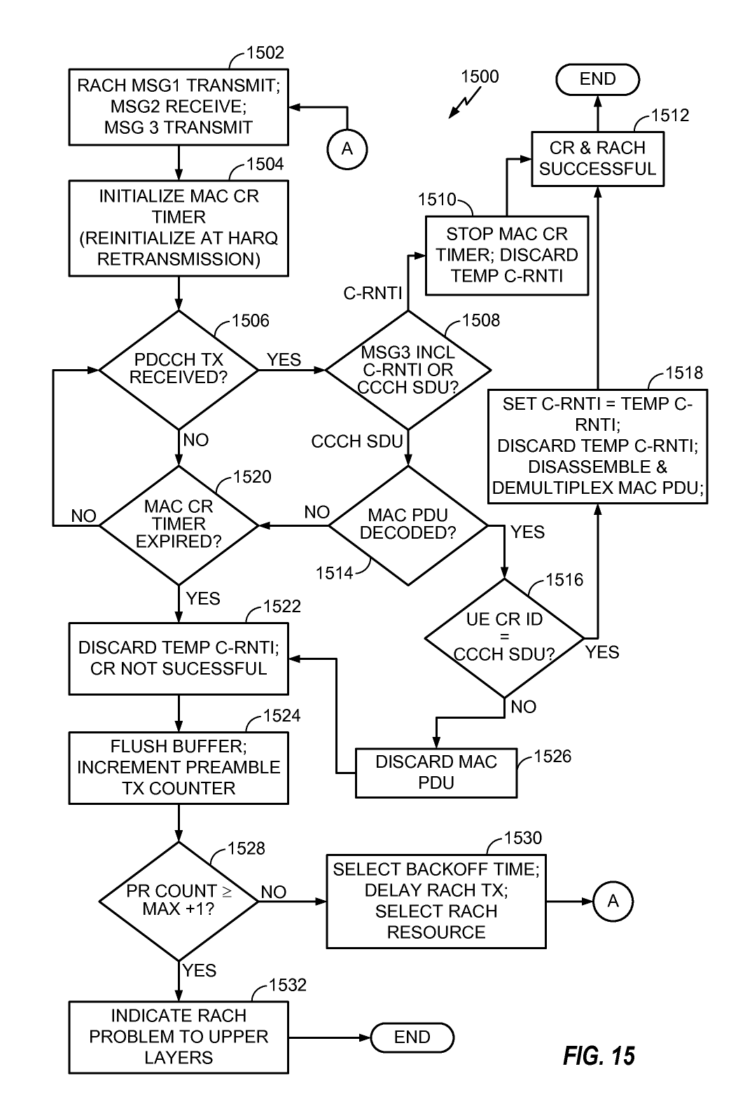

Further details and relationships between actions that may be performed by user equipment in different embodiments of an ULDAR RACH procedure are summarized by the various blocks 1500 shown in FIG. 15. Block 1502 refers to a sequence of RACH MSG1 transmission, MSG2 receipt, and MSG3 transmission performed by the UE as described hereinabove. Likewise, block 1504 refers to the UE initializing a MAC contention resolution timer in response to transmitting the MSG3 request with the uplink data. The UE may restart the CR timer at each hybrid automatic repeat request (HARM) retransmission. The UE may then, regardless of the possible occurrence of a measurement gap, monitor the PDCCH until the CR timer expires or until the UE stops the timer in response to specified conditions.

At block 1506, a first branch point distinguishing different cases or embodiments, concerns whether or not the UE subsequently (after transmitting MSG3) receives a PDCCH transmission. If the RACH is proceeding normally, the UE should receive a PDCCH transmission in response to MSG3. If the UE does not receive a PDCCH transmission and the MAC CR timer is not expired, the UE continues to wait for the PDCCH transmission 1506. However, if the MAC CR timer expires without the UE receiving a PDCCH transmission, the UE discards the temporary C-RNTI and considers the contention resolution/RACH procedure not successful 1522.

Referring again to block 1506, if the UE receives a PDCCH transmission in response to MSG3, a second branch point 1508 turns on whether or not the UE included a C-RNTI or a CCCH SDU in MSG3. If the UE included a C-RNTI, then the PDCCH is addressed to the included C-RNTI. In response to receiving this PDCCH transmission, the UE may stop or reset the MAC CR timer and discard the temporary C-RNTI 1510. The UE may then regard the contention resolution/RACH procedure as having successfully completed uplink of the data included in MSG3 from the UE 1512. This is true whether the RACH was originally initiated by the MAC sublayer itself, resulting in the MSG4 PDCCH transmission to the C-RNTI containing an UL grant for a new transmission; or whether, in the alternative, the RACH procedure was initiated by a PDCCH order and the MSG4 PDCCH order addressed to the C-RNTI does not include a new UL grant.

In the alternative, if at 1508 the MSG3 transmission includes a CCCH SDU, the UE determines 1514 whether the MAC PDUs in the MSG4 received transmission can be successfully decoded. If the MAC PDUs cannot be decoded, the MSG4 transmission is ignored and flow reverts to block 1520. If the MAC PDUs can be decoded, the UE checks whether the UE CR ID coded in the MAC PDUs matches the CCCH SDU included in MSG3, at block 1516. If the UE CR ID matches the CCCH SDU, then the UE may set the C-RNTI equal to the value of the temporary C-RNTI, discard the temporary C-RNTI, and finish disassembly and de-multiplexing of the MAC PDUs 1518. In addition, the UE may then regard the contention resolution/RACH procedure as having successfully completed uplink of the data included in MSG3 from the UE 1512.

Conversely, if the UE CR ID does not match the CCCH SDU, the UE may discard the successfully decoded MAC PDU 1526, discard the temporary C-RNTI, and regard the CR/RAC procedure as unsuccessful 1522. Regarding the CR/RACH procedure as unsuccessful means that the UE will attempt to again uplink the data included in MSG3.

Accordingly, the UE may flush the HARQ buffer used for transmission of the MAC PDU in the MSG3 buffer, and increment a preamble transmission counter by one 1524. At block 1528, the UE may determine whether the preamble transmission counter exceeds a maximum value, e.g., “MAX+1.” If the counter exceeds a predetermined maximum value, the UE may indicate a RACH problem to upper layers 1532. If the counter does not exceed the maximum threshold value, the UE may as indicated at block 1530, based on a predetermined backoff parameter in the UE, select a random backoff time according to a uniform distribution between zero and the backoff parameter, delay a subsequent RACH MSG1 transmission by the backoff time and proceed to the selection of a RACH resource, before reverting to block 1502.

It is noted that various aspects are described herein in connection with user equipment. User equipment can also be referred to as a system, a user device, a subscriber unit, subscriber station, terminal, mobile device, mobile station, remote station, remote terminal, access terminal, user terminal, user agent, or access terminal. A user device can be a cellular telephone, a cordless telephone, a Session Initiation Protocol (SIP) phone, a wireless local loop (WLL) station, a PDA, a handheld device having wireless connection capability, a module within a terminal, a card that can be attached to or integrated within a host device (e.g., a PCMCIA card) or other processing device connected to a wireless modem.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Furthermore, the one or more versions may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. Advantageously, the technology as disclosed herein should be accomplished within design guidelines for minimizing costs and disruptions to existing network infrastructure, while ensuring effective security. For example, implementations should be backward compatible with existing mobile stations, as well as new devices. The foregoing exemplary guidelines may be helpful in designing useful embodiments, but do not limit the technology described herein to a particular design constraint or set of constraints.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device, carrier, or medium.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

What is claimed is:

1. A method, comprising:
receiving, an access response to a random access channel (RACH) procedure preamble message to acquire an uplink grant from a node of a wireless communication system, wherein the access response provides an uplink grant to a user equipment (UE) for a request for authorization to transmit uplink data to the node; and
transmitting the request for authorization including the uplink data to the node in response to determining that the access response message provides an uplink grant sufficient to empty the UE's data buffer, thereby enabling termination of the RACH procedure without requiring any subsequent uplink grant from the node.

2. The method of claim 1, further comprising providing an indication that the UE's data buffer is empty in the request for authorization.

3. The method of claim 2, wherein providing the indication is performed by using a Buffer Status Report (BSR) data signal.

4. The method of claim 1, further comprising initializing a contention resolution timer in response to transmitting the request for authorization.

5. The method of claim 4, further comprising including a Cell Radio Network Temporary ID (C-RNTI) Media Access Control (MAC) control element in the request for authorization.

6. The method of claim 5, further comprising stopping the contention resolution timer and discarding a temporary C-RNTI, in response to receiving a Physical Downlink Control Channel (PDCCH) transmission addressed to the C-RNTI after transmitting the request for authorization.

7. The method of claim 5, further comprising including a Common Control Channel (CCCH) Service Data Unit (SDU) in the request for authorization.

8. The method of claim 7, further comprising stopping the contention resolution timer and discarding a temporary C-RNTI, in response to determining that a UE Contention Resolution Identity decoded from a MAC Protocol Data Unit (PDU) matches the CCCH SDU.

9. The method of claim 8, further comprising disassembling and demultiplexing the MAC PDU, further in response to determining that a UE Contention Resolution Identity decoded from a MAC Protocol Data Unit (PDU) matches the CCCH SDU.

10. The method of claim 5, further comprising discarding a temporary C-RNTI in response to expiration of the contention resolution timer.

11. The method of claim 10, further comprising reinitiating the RACH procedure for uplink of data after waiting for a backoff period.

12. A computer program product, comprising:
a computer-readable storage medium comprising code for causing a computer to:
receive, an access response to a random access channel (RACH) procedure preamble message to acquire an uplink grant from a node of a wireless communication system, wherein the access response provides an uplink grant to a user equipment (UE) of a request for authorization to transmit uplink data to the node; and
transmit the request for authorization including the uplink data to the node in response to determining that the access response message provides an uplink grant sufficient to empty the UE's data buffer, thereby enabling termination of the RACH procedure without requiring any subsequent uplink grant from the node.

13. The computer program product of claim 12, wherein the computer-readable storage medium further comprises code for causing a computer to provide an indication that the UE's data buffer is empty in the request for authorization.

14. The computer program product of claim 12, wherein the computer-readable storage medium further comprises code for causing a computer to provide the indication using a Buffer Status Report (BSR) data signal.

15. The computer program product of claim 12, wherein the computer-readable storage medium further comprises code for causing a computer to initialize a contention resolution timer in response to transmitting the request for authorization.

16. The computer program product of claim 15, wherein the computer-readable storage medium further comprises code for causing a computer to include a Cell Radio Network Temporary ID (C-RNTI) Media Access Control (MAC) control element in the request for authorization.

17. The computer program product of claim 16, wherein the computer-readable storage medium further comprises code causing a computer to stop the contention resolution timer the C-RNTI, in response to receiving a Physical Downlink Control Channel (PDCCH) transmission addressed to the C-RNTI after transmitting the request for authorization.

18. The computer program product of claim 15, wherein the computer-readable storage medium further comprises code for causing a computer to include a Common Control Channel (CCCH) Service Data Unit (SDU) in the request for authorization.

19. The computer program product of claim 18, wherein the computer-readable storage medium further comprises code for causing a computer to stop the contention resolution timer and discard a temporary C-RNTI, in response to determining that a UE Contention Resolution Identity decoded from a Protocol Data Unit (PDU) matches the CCCH SDU.

20. The computer program product of claim 19, wherein the computer-readable storage medium further comprises code for causing a computer to disassemble and demultiplex the MAC PDU, further in response to determining that a UE Contention Resolution Identity decoded from a MAC Protocol Data Unit (PDU) matches the CCCH SDU.

21. The computer program product of claim 16, wherein the computer-readable storage medium further comprises code for causing a computer to discard a temporary C-RNTI in response to expiration of the contention resolution timer.

22. The computer program product of claim 21, wherein the computer-readable storage medium further comprises code for causing a computer to reinitiate the RACH procedure for uplink of data after waiting for a backoff period.

23. An apparatus, comprising:
means for receiving, an access response to a random access channel (RACH) procedure preamble message to acquire an uplink grant from a node of a wireless communication system, wherein the access response provides an uplink grant to a user equipment (UE) for a request for authorization to transmit uplink data to the node; coupled to
means for transmitting the request for authorization including the uplink data to the node in response to determining that the access response message provides an uplink grant sufficient to empty the UE's data buffer, thereby enabling termination of the RACH procedure without requiring any subsequent uplink grant from the node.

24. The apparatus of claim 23, further comprising means for providing an indication that the UE's data buffer is empty in the request for authorization.

25. The apparatus of claim 23, further comprising means for providing the indication using a Buffer Status Report (BSR) data signal.

26. The apparatus of claim 23, further comprising means for initializing a contention resolution timer in response to transmitting the request for authorization.

27. The apparatus of claim 26, further comprising means for including a Cell Radio Network Temporary ID (C-RNTI) Media Access Control (MAC) control element in the request for authorization.

28. The apparatus of claim 26, further comprising means for stopping the contention resolution timer the C-RNTI, in response to receiving a Physical Downlink Control Channel (PDCCH) transmission addressed to the C-RNTI after transmitting the request for authorization.

29. The apparatus of claim 26, further comprising means for including a Common Control Channel (CCCH) Service Data Unit (SDU) in the request for authorization.

30. The apparatus of claim 29, further comprising means for stopping the contention resolution timer and discarding a temporary C-RNTI, in response to determining that a UE Contention Resolution Identity decoded from a Protocol Data Unit (PDU) matches the CCCH SDU.

31. The apparatus of claim 30, further comprising means for disassembling and demultiplexing the MAC PDU, further in response to determining that a UE Contention Resolution Identity decoded from a MAC Protocol Data Unit (PDU) matches the CCCH SDU.

32. The apparatus of claim 27, further comprising means for discarding a temporary C-RNTI in response to expiration of the contention resolution timer.

33. The apparatus of claim 32, further comprising means for reinitiating the RACH procedure for uplink of data after waiting for a backoff period.

34. A wireless communication apparatus comprising:
a memory holding instructions for receiving, an access response to a random access channel (RACH) procedure preamble message to acquire an uplink grant from a node of a wireless communication system, wherein the access response provides an uplink grant to a user equipment (UE) for a request for authorization to transmit uplink data to the node, and, transmitting the request for authorization including the uplink data to the node in response to determining that the access response message provides an uplink grant sufficient to empty the UE's data buffer, thereby enabling termination of the RACH procedure without requiring any subsequent uplink grant from the node; and
a processor that executes the instructions.

35. The apparatus of claim 34, wherein the memory holds further instructions for providing an indication that the UE's data buffer is empty in the request for authorization.

36. The apparatus of claim 34, wherein the memory holds further instructions for providing the indication using a Buffer Status Report (BSR) data signal.

37. The apparatus of claim 34, wherein the memory holds further instructions for initializing a contention resolution timer in response to transmitting the request for authorization.

38. The apparatus of claim 37, wherein the memory holds further instructions for including a Cell Radio Network Temporary ID (C-RNTI) Media Access Control (MAC) control element in the request for authorization.

39. The apparatus of claim 38, wherein the memory holds further instructions for stopping the contention resolution timer the C-RNTI, in response to receiving a Physical Downlink Control Channel (PDCCH) transmission addressed to the C-RNTI after transmitting the request for authorization.

40. The apparatus of claim 38, wherein the memory holds further instructions for including a Common Control Channel (CCCH) Service Data Unit (SDU) in the request for authorization.

41. The apparatus of claim 40, wherein the memory holds further instructions for stopping the contention resolution timer and discarding a temporary C-RNTI, in response to determining that a UE Contention Resolution Identity decoded from a Protocol Data Unit (PDU) matches the CCCH SDU.

42. The apparatus of claim 41, wherein the memory holds further instructions for disassembling and demultiplexing the MAC PDU, further in response to determining that a UE Contention Resolution Identity decoded from a MAC Protocol Data Unit (PDU) matches the CCCH SDU.

43. The apparatus of claim 38, wherein the memory holds further instructions for discarding a temporary C-RNTI in response to expiration of the contention resolution timer.

44. The apparatus of claim 42, wherein the memory holds further instructions for reinitiating the RACH procedure for uplink of data after waiting for a backoff period.
